(19) United States
(12) Patent Application Publication
(10) Pub. No.: US 2005/0285729 A1
(43) Pub. Date: Dec. 29, 2005

(54) Mike lights

(76) Inventor: Michael Lynn Harrison, Savannah, TN (US)

Correspondence Address: MICHAEL LYNN HARRISON, P.O. BOX 43, SAVANNAH, TN, 38372, US

(21) Appl. No.: 10/773,575

(22) Filed: Jun. 28, 2004

(51) Int. Cl. B60Q 1/00

(52) U.S. Cl. 340/457.1

(57) ABSTRACT

My invention is a system of small colored lights that will indicate to anyone approaching the front of a vehicle or following from the rear of a vehicle as to whether the occupants are wearing their seatbelts. The system of lights will be clearly visible when approaching the vehicle of following the vehicle.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

This invention will assist law enforcement in enforcing the use of seatbelts in motor vehicles. Many states have enacted laws that require occupants of a vehicle to wear their seatbelt. Many times it is hard for law enforcement officers to observe if an occupant of a vehicle has their seatbelt on or not. This invention will allow law enforcement officers to be able to recognize at a distance if the occupants of a vehicle have their seatbelts on. Many people are killed or seriously injured each year because they were not wearing their seatbelt. This will also cause more people to wear their seatbelts and save many lives in the process.

### BRIEF SUMMARY OF THE INVENTION

The invention is a system of small lights that are placed on a vehicle that indicate at a distance if the occupants are wearing their seatbelts. When someone approaches the front of the vehicle either the red or green light will be clearly visible indicating if the occupants are wearing their seatbelt. Also, there will be lights located on the back of the vehicle that will be red or green indicating if the occupants are wearing their seatbelt. The lights will be clearly visible from a distance and allow law enforcement officer to observe if the occupants are wearing their seatbelts. This will make it easier for them to enforce the seatbelt laws. This will cause people to wear their seatbelt and reduce the number of injuries and deaths.

### BRIEF DESCRIPTION OF SEVERAL VIEWS OF THE DRAWING

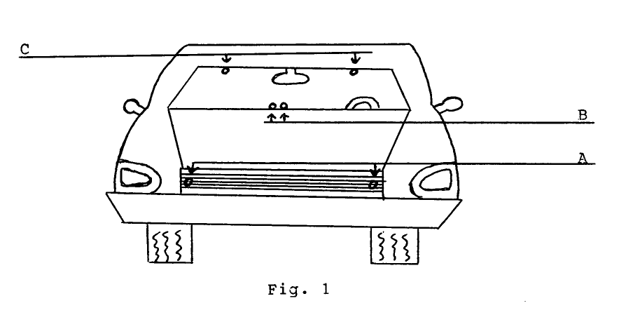

In FIG. 1 the drawing is a view of the front of a vehicle. This view is how the invention would appear to someone approaching the vehicle. It shows the placement of the lights in different locations on the front of the vehicle. (A) has the placement of the lights in the front grill of the vehicle. (B) has the placement on the front part of the dashboard near the front windshield. (C) has the placement of the lights in the front top area of the front windshield.

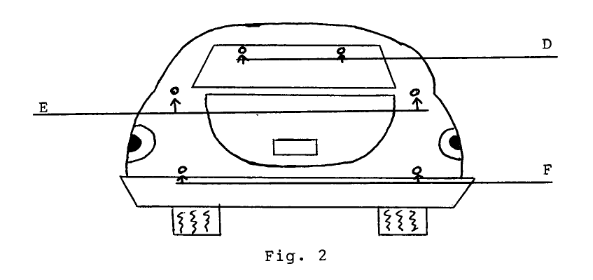

In FIG. 2 the drawing is a view of the rear of the vehicle. This view is how the invention would appear to someone following the vehicle. It shows the placement of the lights in different locations on the rear of the vehicle. (D) has the placement of the lights in the rear window of the vehicle. (E) has the placement of the lights on the back trunk of the vehicle. (F) has the placement of the lights on the rear bumper of the vehicle.

### DETAILED DESCRIPTION OF THE INVENTION

The Invention is a system of small colored lights that are mounted on a vehicle that will indicate whether or not the occupants of the vehicle are wearing their seatbelts. The lights can be placed in several different locations on the vehicle. First, the lights can be placed in front grill of the vehicle in such a manner as to be clearly visible to on coming traffic. Second, the lights can be placed on the front dashboard close to the front windshield so they can clearly be visible to oncoming traffic. Finally, the lights can be placed at the top of the front windshield so that they can clearly be visible to oncoming traffic. Also the lights can be mounted on the rear of the vehicle. They can be mounted at the top of the rear window so as to be clearly visible from the rear. They can be mounted on the back trunk deck of the vehicle in such a manner as to be clearly visible from the rear of the vehicle. Finally, the lights can be mounted on the back bumper of the vehicle in such a manner as to be clearly seen from the rear of the vehicle. The important aspect of mounting the lights is to place them in a location that can be easily seen by someone approaching the vehicle or following the vehicle. The lights are color coded with green indicating that the occupants are wearing their seatbelts and red to indicate that the occupants are not wearing their seatbelts. The lights will be connected to the seatbelts that are located in the front seat of the vehicle. The lights on the driver side will be connected to the driver side seatbelt and the lights on the passenger side will be connected to the passenger side seatbelt. There will be a contact switch in the seat belt that will make the green light come on once the vehicle is in motion and the seatbelt is buckled. If the vehicle is in motion and the seatbelt is not buckled the red light will come on.

1. What I claim as my invention is the use of a system of small lights that indicate to anyone approaching the vehicle from the front or following a vehicle from the rear that indicates whether or not the occupants are wearing their seatbelts.
